(19) United States
(12) Patent Application Publication
(10) Pub. No.: US 2026/0167577 A1
(43) Pub. Date: Jun. 18, 2026

(54) METHODS FOR CREATING CEMENT-BASED COUNTERTOPS AND TABLETOPS

(71) Applicant: Travis Reitmayer, Cheney, KS (US)

(72) Inventor: Travis Reitmayer, Cheney, KS (US)

(21) Appl. No.: 18/984,707

(22) Filed: Dec. 17, 2024

(51) Int. Cl. C04B 41/52; A47B 96/18; A47B 96/20; B28B 19/00; B32B 5/02; B32B 13/14; C04B 41/45; C04B 41/48; C04B 41/63; C04B 41/71

(52) U.S. Cl. CPC C04B 41/52; A47B 96/18; A47B 96/206; B28B 19/0092; B32B 5/028; B32B 13/14; C04B 41/4539; C04B 41/4596; C04B 41/483; C04B 41/4853; C04B 41/63; C04B 41/71; B32B 2479/00

(57) ABSTRACT

Methods of creating tabletops, countertops, and other tops with a layer of planar material; a waterproofing layer, a concreted board layer; a base coat mud compound layer; at least one layer of mesh embedded in the base coat mud compound layer; a bonding agent layer; a finish coat mud compound layer; and an epoxy layer.

### BACKGROUND OF THE INVENTION

Concrete countertops and tabletops have gained popularity recently for their unique aesthetic and versatility. Concrete tops can be molded into virtually any shape and can be colored, stained, or polished to achieve a variety of looks for a high level of customization to match any design style. Concrete is also strong and durable and can withstand significant wear and tear. But concrete tops have limitations and disadvantages. For example, they are heavy and therefore often require additional support and reinforcement. They can also crack over time, especially if not installed correctly, and are porous, and thus can absorb liquids and stains if not properly and regularly sealed.

### SUMMARY OF THE INVENTION

Embodiments of the present invention address one or more of the above-mentioned problems and provide a distinct advance in the art of tabletops, countertops, and similar tops for other surfaces. Particularly, embodiments of the invention provide methods of creating tabletops, countertops, and other tops that have all the advantages of concrete tops but none of the disadvantages.

In accordance with one embodiment of the invention, a piece of plywood or other support material is first cut to a desired shape and size for the top and then sealed with a waterproofing solution. A piece of cement board or other material is then cut to the same desired shape and size and fastened to the plywood with screws, adhesives, and/or other fasteners to form a substrate.

A base coat mud compound containing polymer-modified cement, an acrylic admixture, and water is then created and applied in a layer over the top and sides of the substrate. relatively heavy mesh material is then wrapped over the top surface and sides of the substrate and pressed into the layer of the base coat mud compound. In some embodiments, a second layer of relatively lighter mesh is wrapped over the first mesh material and pressed into the base coat mud compound. For tops with chiseled edges, the mesh is not wrapped around any sides or edges that will be later chiseled. After the layer or layers of mesh have been pressed into the base coat mud, the base cut mud is smoothed to a desired texture. If any mesh is not covered by the base coat mud, additional base coat mud may be applied over the mesh and smoothed as needed.

After the base coat mud has dried, a bonder is applied over it and allowed to dry. Next, a finish coat mud compound containing a polymer-modified finishing cement, an acrylic admixture, any desired powder or liquid coloring agents, and water is then created and applied in a layer over the base coat mud, smoothed as desired, and allowed to dry. Finally, an epoxy sealant is applied over the finish coat mud compound and allowed to dry.

Tabletops, countertops, and other tops created as described herein have many advantages. They are lighter than conventional concrete tops and therefore require less support; they are less likely to crack and therefore more durable; and they are impervious to liquids and other contaminants and therefore less likely to become stained or otherwise discolored. They can also be more easily formed in nearly any shape, size and texture.

In other embodiments, some of the above-described layers can be applied over existing concrete tops, marble tops, wood tops, or tops made of other materials to achieve the same desired aesthetic on existing tops.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a perspective view of a tabletop constructed in accordance with embodiments of the present invention.

FIG. 2 is a perspective view of another tabletop constructed in accordance with embodiments of the present invention.

FIG. 3 is a flow chart depicting exemplary steps in a method of the present invention.

FIG. 4 is a vertical cross section, not to scale, of a tabletop or other top constructed in accordance with embodiments of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

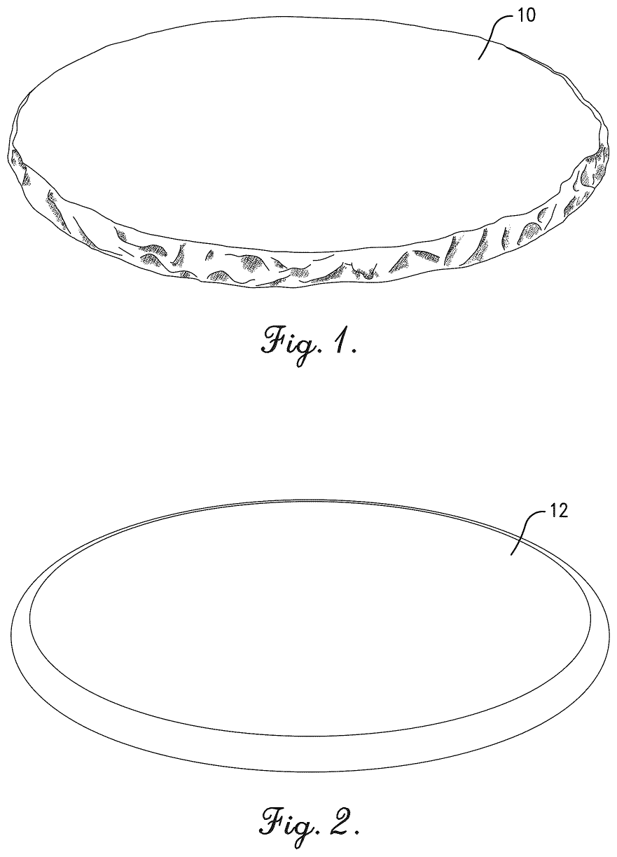

FIGS. 1 and 2 depict exemplary tabletops 10, 12 created in accordance with embodiments of the invention. The tops be of any shape and size; may have square edges, bull-nosed edges, chiseled edges, or any other edges; and smooth or textured upper surfaces. The invention is not limited to the illustrated tabletops, as the methods of the invention and equivalent methods may be used to create tabletops, countertops, and other tops of nearly any shape, size, and texture. As used herein, the term “tops” is meant to encompass countertops, tabletops, workbench tops, furniture tops, and any other upper surface on which items may be placed.

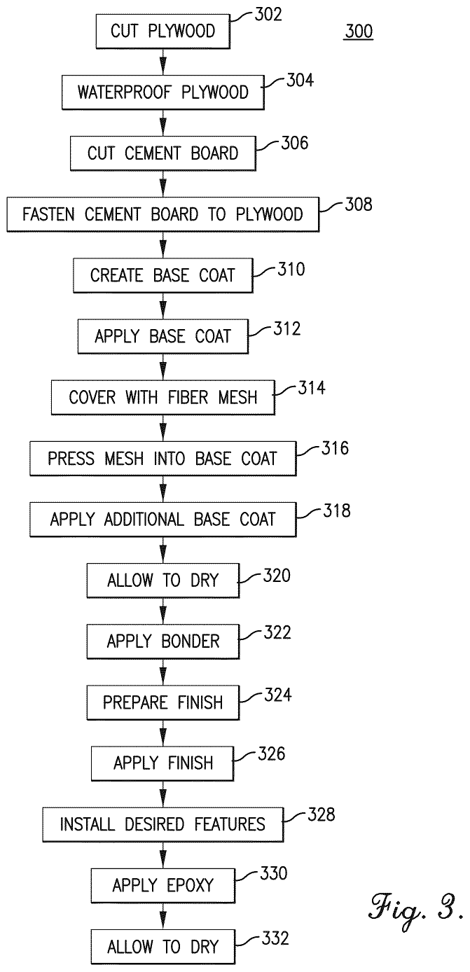

The flow chart of FIG. 3 depicts exemplary steps in a method 300 of constructing a top in accordance with embodiments of the present invention. In some alternative implementations, the functions noted in the various blocks may occur out of the order depicted in FIG. 3. For example, two blocks shown in succession may in fact be executed substantially concurrently, or the blocks may sometimes be executed in the reverse order or other order. Moreover, some embodiments of the invention may have less steps than illustrated or additional steps not illustrated.

As depicted in block 302, a piece of plywood, plastic sheet, or any other planar support material is first cut to a desired shape and size for the tabletop or other top. In one embodiment, ¾″ plywood is used, but plywood or other materials of other thicknesses may be used. Similarly, materials such as solid wood, marble, steel, tin, or other support materials may be used instead of plywood, but plywood is preferred because its relatively lightweight, strong enough for most uses, and relatively inexpensive. The plywood is then sealed with a waterproofing solution as depicted in block 304. The waterproofing material may be a water-based transparent acrylic sealer such as those sold by Parex USA or any other equivalent waterproofing solution or compound.

As depicted in blocks 306 and 308, a piece of cement board is then cut to approximately the same shape and size as the plywood and then fastened to the plywood with screws, adhesives, and/or other fasteners to form a multi-layer substrate. The cement board may be ¼″ or ½″ PermaBASE® cement board or any equivalent cement board. In other embodiments, boards made of materials other than cement may be used, but cement board is preferred due to its relative low weight, high strength, and ability to withstand prolonged exposure to moisture and extreme temperatures.

A base coat mud compound is then created as depicted in block 310. In one embodiment, the base coat mud compound contains polymer-modified cement such as Merlex BASEX, a bonding agent such as Merlex Acrylex acrylic admixture, and water. These components are mixed according to Merlex recommendations to achieve a consistency approximately the same as wet cement.

As depicted in block 312, a layer of the base coat mud compound is then applied over the top and sides of the substrate. Any amount of the base coat mud material may be applied over the substrate. The base coat mud material may be applied in any conventional manner.

Before the base coat mud compound dries, a mesh material is then wrapped over the top surface and sides of the substrate and pressed into the base coat mud compound as depicted in blocks 314, 316. The mesh is preferably a relatively heavy 15-20 oz EIF fiberglass mesh such as those sold by Parex, Boen, Temu, or Omega Products. In some embodiments, a second layer of relatively lighter mesh is wrapped over the first mesh material and pressed into the layer of the base coat mud compound. Applicant has discovered that two layers of mesh, with the first layer being heavier than the second layer, improves the durability of the top while making it easier to smooth and finish. For tops with chiseled edges, the mesh is not wrapped around any sides or edges that will be later chiseled.

After the layer or layers of mesh have been pressed into the base coat mud, the base cut mud is smoothed to a desired texture. If any mesh is not covered by the base coat mud, additional base coat mud may be applied over the mesh and smoothed as needed as depicted in block 318. The base coat mud with the embedded mesh is than allowed to dry and harden as depicted in block 320. A bonding agent such as Merlex Acrylex acrylic admixture bonder is then applied over it and allowed to dry as depicted in block 322.

Next, a finish coat mud compound is created as depicted in block 324. In one embodiment, the finish coat contains a polymer-modified finishing cement such as Merlex Super Shower Finish, an acrylic admixture such as Merlex Acrylex acrylic admixture, any desired powder or liquid coloring agents, and water. The finish coat mud compound is then applied in a layer over the base coat mud, smoothed as desired, and allowed to dry as depicted in bock 326. LED lights, art, or any other features may be placed over the finish coat as depicted in block 328/ Finally, an epoxy sealant is applied over the finish coat mud compound and allowed to dry as depicted in block 330.

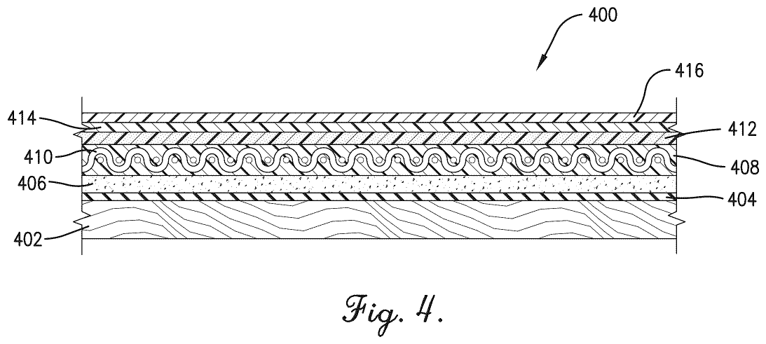

As shown in FIG. 4, a top 400 created in accordance with embodiments of the invention includes a plywood layer 402; a waterproofing layer 404, a concreted board layer 406; a base coat mud compound layer 408; at least one layer of mesh 410 embedded in the base coat mud compound layer; a bonding agent layer 412; a finish coat mud compound layer 414; and an epoxy layer 416.

In other embodiments, some of the above-described layers can be applied over existing concrete tops, marble tops, wood tops, or tops made of other materials to achieve the same desired aesthetic on existing tops. For example, instead of creating a substrate with plywood and concrete board, the base coat mud compound, mesh, bonding agent, finish coat mud compound layer, and epoxy layer may be applied over existing tops.

Tabletops, countertops, and other tops created as described herein have many advantages. They are lighter than conventional concrete tops and therefore require less support; less likely to crack and therefore more durable; and impervious to liquids and other contaminants and therefore less likely to become stained or otherwise discolored. They can also be more easily formed in nearly any shape, size and texture. Moreover, in embodiments in which some of the layers are applied over existing tops, cracks, chips, stains, and other imperfections in the existing tops can be covered to create a new-looking top.

### ADDITIONAL CONSIDERATIONS

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method of creating a top, the method comprising:
cutting a piece of planar material to desired dimensions for the top;
applying a waterproofing solution to the planar material;
cutting a piece of cement board to the desired dimensions of the top;
fastening the cement board to the planar material;
creating a base coat mud compound;
applying a first layer of the base coat mud compound over the cement board;
pressing a first layer of mesh material into the first layer of the base coat mud compound;
pressing a second layer of mesh material into the first layer of the base coat mud compound over the first layer of mesh material;
applying a second layer of the base coat mud compound over the second layer of mesh material;
smoothing the second layer of the base coat mud compound to form a desired surface;
allowing the first and second layers of the base coat mud compound to dry;
applying a bonder over the second layer of the base coat mud compound;
creating a finish coat mud compound;
applying a layer of the finish coat mud compound over the second layer of the base coat mud compound;
allowing the layer of the finish coat mud compound to dry; and
applying a sealant over the layer of the finish coat mud compound.

2. The method of claim 1, wherein the top is selected from the group consisting of a tabletop, a countertop, a bar top, a furniture top, and a workbench top.

3. The method of claim 1, wherein the creating the base coat mud compound step comprises mixing together a polymer-modified compound, an acrylic polymer emulsion and water.

4. The method of claim 1, wherein the first layer of mesh material is a 15-20 oz fiberglass mesh.

5. The method of claim 1, wherein the second layer of mesh material is a 4 oz fiberglass mesh.

6. The method of claim 1, wherein the bonder is an acrylic polymer emulsion.

7. The method of claim 1, wherein the creating the finish coat mud compound step comprises mixing together a polymer-modified cement finish compound, an acrylic polymer emulsion, a coloring agent, and water.

8. The method of claim 1, wherein the sealant applied over the finish coat mud compound is an epoxy compound.

9. A top for a table, counter, bar, piece of furniture, or work bench, the top comprising:
a piece of planar material;
a waterproofing solution applied to the planar material;
a piece of cement board fastened over the planar material;
a base coat mud compound applied over the cement board;
a first layer of mesh material in the first layer of the base coat mud compound;
a second layer of mesh material in the first layer of the base coat mud compound;
a second layer of the base coat mud compound over the second layer of mesh material;
a bonder applied over the second layer of the base coat mud compound;
a finish coat mud compound applied over the second layer of the base coat mud compound; and
a sealant over the layer of the finish coat mud compound.

10. The top of claim 9, wherein the base coat mud compound comprises a mixture of a polymer-modified compound, an acrylic polymer emulsion, and water.

11. The top of claim 9, wherein the first layer of mesh material is a 15-20 oz fiberglass mesh.

12. The top of claim 9, wherein the second layer of mesh material is a 4 oz fiberglass mesh.

13. The top of claim 9, wherein the bonder is an acrylic polymer emulsion.

14. The top of claim 9, wherein the finish coat mud compound is a mixture of a polymer-modified cement finish compound, an acrylic polymer emulsion, a coloring agent, and water.

15. The top of claim 9, wherein the sealant is an epoxy compound.

16. A method of refurbishing a top, the method comprising:
creating a base coat mud compound;
applying a first layer of the base coat mud compound over the top;
pressing a first layer of mesh material into the first layer of the base coat mud compound;
allowing the first layer of the base coat mud compound to dry;
applying a bonder over the second layer of the base coat mud compound;
creating a finish coat mud compound;
applying a layer of the finish coat mud compound over the second layer of the base coat mud compound; and
allowing the layer of the finish coat mud compound to dry.

17. The method of claim 16, further comprising:
pressing a second layer of mesh material into the first layer of the base coat mud compound over the first layer of mesh material;
applying a second layer of the base coat mud compound over the second layer of mesh material; and
smoothing the second layer of the base coat mud compound to form a desired surface.

18. The method of claim 16, further comprising applying a sealant over the layer of the finish coat mud compound.

19. The method of claim 16, wherein the creating the base coat mud compound step comprises mixing together a polymer-modified compound, an acrylic polymer emulsion, and water.

20. The method of claim 16, wherein the creating the finish coat mud compound step comprises mixing together a polymer-modified cement finish compound, an acrylic polymer emulsion, a coloring agent, and water.
